(19) United States
(12) Patent Application Publication
(10) Pub. No.: US 2010/0144966 A1
(43) Pub. Date: Jun. 10, 2010

(54) Liquid oligomer composition containing hydroxyamine adducts and method of manufacturing thereof

(75) Inventors: Olga Birukov, Haifa (IL); Dmitry Beilin, Haifa (IL); Oleg Figovsky, Haifa (IL); Alexander Leykin, Haifa (IL); Leonid Shapovalov, Haifa (IL)

Correspondence Address: Urania Juang, 266 E. Gish Road, San Jose, CA, 95070, US

(73) Assignees: Polymate, Ltd; Nanotech Industries, Inc.

(21) Appl. No.: 12/315,580

(22) Filed: Dec. 4, 2008

(51) Int. Cl. C08L 69/00

(52) U.S. Cl. 524/800; 525/461

(57) ABSTRACT

Proposed is a liquid oligomer composition that contains a hydroxyamine adduct and a liquid reacting oligomer. The hydroxyamine adduct includes an epoxy-amine adduct, which contains at least one primary amine group that is a product of the reaction of an epoxy compound with at least one terminal oxyrane group and at least one amine that contains at least two primary amino groups. In order to form the epoxy-amine adduct, 1 to 15 moles of at least one amine are reacted per equivalent of the aforementioned epoxy compound. The composition also contains at least one compound with one or more terminal cyclocarbonate groups. A method of manufacturing a liquid oligomer composition on the basis of the above compounds is also proposed.

### FIELD OF THE INVENTION

The present invention relates to liquid oligomer compositions that contain hydroxyamine adducts. More specifically, the invention relates to liquid oligomer compositions of the aforementioned type, wherein the hydroxyamine adducts are formed from an epoxy-amine adduct and a cyclocarbonate oligomer without the use of isocyanate intermediates. In particular, the invention may find application in preparation of curable coating materials.

### BACKGROUND OF THE INVENTION

Epoxy-amine adducts, which may be epoxy-terminated or amine-terminated, are well known in the art. For example, U.S. Pat. No. 5,508,324 issued to Cook in 1996 describes polyamine-epoxy adducts and curable coating compositions comprising blends of polyamine-epoxy adducts and polyepoxides.

Certain hydroxyl and amine groups containing adducts (also referred to as aminourethanes) and polymers prepared therefrom are also known in the art. Such products were disclosed in USSR Inventor's Certificate No. 413824 issued to Petrov, Rappoport, et al, in 1969. Many inventions describe aminourethanes as hardeners for other oligomers. Mainly they relate to waterborne compositions.

U.S. Pat. No. 4,820,830 issued to Blank in 1989 and U.S. Pat. No. 5,134,205 issued to Blank in 1992 describe hydroxyalkyl-carbamate compounds prepared by reacting cyclic carbonates, for example, ethylene carbonate, propylene carbonate, or butylene carbonate, with selected aliphatic diamines. The hydroxyalkyl carbamates are prepared without the use of isocyanate intermediates and can be used in coating compositions in conjunction with a crosslinking agent such as melamine-formaldehyde resin.

Also, β-hydroxyurethane compounds (which are urethane compounds having a hydroxyl group in the beta position relative to the carbamoxy group) are described in U.S. Pat. No. 4,435,559 issued to Valko in 1984. These β-hydroxy urethane compounds are prepared by reacting an isocyanate, for example, isophorone diisocyanate and 1,6-hexamethylene diisocyanate, with 1,2-polyols, for example, 1,2-butanediol or 1,2-hexanediol, or a combination of 1,2-polyols with a conventional blocking agent, such as amino alcohol. The β-hydroxyurethane compound is prepared under conditions such that virtually no free isocyanate groups remain in the resultant product. These β-hydroxy urethane compounds are useful in curable compositions as cross-linking agents in conjunction with other composition components or in self-cross-linkable compositions.

U.S. Pat. No. 5,340,889 issued to Crawford, et al, in 1994 describes liquid hydroxy-urethane products having terminal cyclocarbonate groups prepared by reacting polyoxyalkylenediamine with a molar excess of bis-carbonate of bis-glycidyl ether, for example, bis-glycidyl ether of neopentyl glycol. The bis-carbonate material reacts with polyoxyalkylenediamine in a molar ratio ranging from (5.0:1) to (2.0:1). This reaction ratio ensures that the resulting product has terminal cyclocarbonate groups.

U.S. Pat. No. 5,677,006 issued to Hoenel, et al, in 1997, U.S. Pat. No. 5,707,741 issued to Hoenel, et al, in 1998, U.S. Pat. No. 5,855,961 issued to Hoenel, et al. in 1999, U.S. Pat. No. 5,935,710 issued to Hoenel, et al, in 1993 relate to waterborne coating compositions, including one or more resins having amino-reactive groups, one or more polyamine curing agents, and one or more aminourethanes. The aminourethanes can be reaction products of (i) oligomeric or polymeric compounds containing at least one, preferably two or more, terminal 2-oxo-1,3-dioxolane groups (cyclic carbonate groups), and (ii) amines containing at least one primary amino group, preferably two or more primary amino groups and, if desired, secondary or tertiary amino groups. The equivalent ratios in the aforementioned components typically range from (1:1) to (1:10), preferably from (1:1.05) to (1:5) and most preferably from (1:1.1) to (1:2), and the end product preferably contains one or more free primary amino groups. If necessary, the composition may also contain pigments, fillers, one or more organic solvents, water, and conventional additives.

U.S. Pat. No. 7,288,595 issued to Swarup, et al, in 2007 provides a reaction product having polyether carbamate groups formed from (A) polyoxyalkylene amine, and (B) cyclic carbonate, in equivalent ratios ranging from (1:0.5) to (1:1.5). Further provided is a process for preparing the aforementioned reaction product. The aforementioned patent also discloses an improved curable coating composition that comprises (1) a reactive functional group-containing polymer, and (2) a curing agent having functional groups reactive with the functional groups of (1).

U.S. Pat. No. 5,175,231 issued to Rappoport, et al, in 1992 describes a urethane that is formed by a new method that does not require the use of an isocyanate. The urethane is formed by reacting a compound containing a plurality of cyclocarbonate groups with a diamine in which two amine groups have different reactions with cyclocarbonate so as to form a urethane oligomer with terminal amine groups. The urethane oligomer can then react with an epoxy resin to form cross-linked polyurethane.

U.S. Pat. No. 5,906,864 issued to Osterhold, et al, in 1999 and No. 6,008,314 issued to Collong, et al, in 1999 relate to epoxy-aminourethane products and to coating media based on aqueous epoxy systems that contain epoxy-aminourethane adducts as hardeners. Epoxy-aminourethane adducts are obtained by the reaction of (A) one or more aminourethanes, which are obtained by the reaction of (a) compounds denoted as a cyclic carbonate group, with (b) one or more amines, each comprising at least one primary amino group, wherein the ratio of the number of cyclic carbonate groups to the number of primary amine groups is (1:10) to (1:1.1), with (B) one or more aqueous epoxy compounds with two or more terminal oxyrane groups, which are obtained by the reaction of (c), at least one member selected from the group consisting of one or more polyalkylene polyethers with primary or/and secondary α-amino groups, with (d) one or more epoxy compounds comprising at least two epoxy groups per molecule, wherein the ratio of the number of primary and/or secondary amino groups of component (c) to the epoxy groups of component (d) is (1:2 to 1:20), and (C) optionally one or more amines that are different from (A) and that comprise at least one primary amino group.

In all cases described above, initial aminourethanes are the products of reactions of (A) compounds designated as a cyclic carbonate group and (B) compounds designated as conventional amines. However, these products are intended for use almost exclusively in waterborne compositions and have low stability under normal conditions.

### SUMMARY OF THE INVENTION

The object of the present invention is to provide hydroxyamine adducts and coating media based on oligomer systems that contain the aforementioned hydroxyamine adducts as hardeners. It is another object to provide the aforementioned hydroxyamine adducts, which are different from existing aminourethanes in that they are products of a reaction of cyclocarbonate compounds, with conventional amines and that at the same time the aforementioned hydroxyamine adducts constitute products of a reaction of cyclocarbonate compounds with epoxy-amine adducts. It is a further object to provide a method of manufacturing a liquid oligomer composition by obtaining a first adduct of epoxy oligomer with the primary amine by reacting at least one primary amine with at least one epoxy oligomer, obtaining a second adduct by reacting the first adduct with a cyclocarbonate, and then mixing the second adduct with the reacted oligomer.

In general, the liquid oligomer composition of the invention contains a hydroxy-amine adduct and a liquid reactionable oligomer. The hydroxy-amine adduct includes an epoxy-amine adduct, which contains at least one primary amine group which is a product of a reaction of an epoxy compound with at least one terminal oxyrane group and at least one amine that contains at least two primary amino groups. In order to form the epoxy-amine adduct, 1 to 15 moles of the at least one amine are reacted per equivalent of the aforementioned epoxy compound. The composition also contains at least one compound with one or more terminal cyclocarbonate groups. A method of manufacturing a liquid oligomer composition on the basis of the above compounds is also proposed.

### DETAILED DESCRIPTION OF THE INVENTION

The hydroxyamine adducts according to one aspect of the invention comprise (A) one or more epoxy-amine adducts, which contain at least one primary amine group comprising reaction products of (a) one or more epoxy compounds with one or more terminal oxyrane groups, and (b) one or more amines, each containing at least two primary amino groups, wherein 1 to 15 moles of polyamine(s) are reacted per epoxy equivalent to form the adduct (A); (B) at least one compound that contains at least one terminal cyclocarbonate group; and (C) optionally, one or more amines that are the same or different from amines (b) and that comprise one or more primary, secondary, or tertiary groups and one or more organic solvents, water, and conventional additives.

A general formula of hydroxy-amine adducts suitable for the present invention is the following:

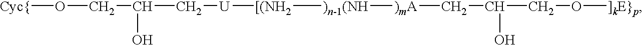

where
Cyc designates a residue of cyclic carbonate,
U designates a urethane group, and
p is a number from 1 to 6.

When preparing epoxy-amine adducts (A), preferably polyamines, which contain primary amine groups capable of reacting with cyclocarbonate groups in adducts (B), are used as the amine component (b). Examples of polyamines (b) suitable for the invention are polyalkylenamines such as diethylenetriamine, triethylenetetramine, tetraethylenepentamine, pentaethylenehexamine, propylenediamine, dipropylenetriamine, also 2,2,4- and/or 2,4,4-trimethylhexamethylenediamine, N,N-bis-(3-aminopropyl)-methylamine, N-aminoethylpiperazine, 1,4-bis-(3′-aminopropyl)-piperazine, N,N-bis-(3-aminopropyl)-ethylenediamine, neopentanediamine, 2-methyl-1,5-pentanediamine, 1,3-diaminopentane, hexamethylenediamine, cycloaliphatic amines such as 1,2- or 1,3-diaminocyclohexane, 1,4-diamino-3,6-diethylcyclohexane, 1,2-diamino-4-ethylcyclohexane, 1,4-diamino-3,6-diethyl-cyclohexane, 1-cyclohexyl-3,4-diaminocyclohexane, isophoronediamine and reaction products thereof, 4,4′-diaminodicyclohexylmethane, and -propane, 2,2-bis-(4-aminocyclohexyl)-methane and -propane, 3,3′-dimethyl-4,4′-diaminodicyclohexyl-methane, 3-amino-1-cyclohexylaminopropane, 1,3- and 1,4-bis-(amininomethyl)-cyclohexane and also polyoxyalkylenamines such as poly(oxypropylenediamine), poly(oxypropylenetriamine), poly(oxyethylenediamine), poly(oxyethylenetriamine).

Araliphatic amines, in particular those in which aliphatic amine groups are present, are also suitable for the purposes of the invention and are exemplified by meta- and para-xylylenediamines. The aforementioned araliphatic amines may be used individually or as a mixture. These amines should be chosen in such a way that they contain at least one but preferably more than one free primary amine group.

Suitable epoxy compounds (a) are, for example, monoepoxides such as propylene oxide, hexene oxide, cyclohexene oxide, or glycidyl ethers such as phenylglycidyl ether, tert-butylglycidyl ether, ethylhexylglycidyl ether, butylglycidyl ether or with glycidyl esters such as the glycidyl ester of versatic acid or polyglycidyl ethers and esters such as polyglycidyl ethers based on polyhydric, preferably dihydric alcohols, phenols, hydrogenation products of these phenols and/or on Novolaks (reaction products of monohydric or polyhydric phenols with aldehydes, in particular formaldehyde, in the presence of acid catalysts).

Epoxy-amine adducts are commercially available and contain components such as benzyl alcohol, alkyl phenol, salicylic acid, etc. Examples of these adducts are D.E.H.® 52 (Dow Chemical), EPI-CURE® 3282 (Hexion), Ancamine® 1618, Ancamine® 1769, and Ancamine® 2143 (Air Products), etc. Conventional pigments, fillers, and surfactants may be used as well.

Cyclocarbonate compounds, which are used in the present invention, comprise five-member alkylene carbonates such as (1,3-dioxolan-2-ones), which can be produced in a known manner by reacting carbon dioxide with epoxy compounds (see, e.g., U.S. Pat. No. 5,175,231, U.S. Pat. No. 5,340,889, and U.S. Pat. No. 7,232,877 issued to Stone, et al, in 2008). These cyclocarbonate compounds can be used as component (B) for the production of hydroxyamine adducts.

Epoxy compounds for production of cyclocarbonates are preferably mono- or polyglycidyl ethers based on mono- or polyhydric aliphatic alcohols, polyhydric cycloaliphatic alcohols, or polyoxyalkylene polyols. The epoxy-equivalent weights of these epoxy compounds are preferably between 44 and 2000, particularly between 58 and 500. The epoxy-equivalent weight is the molecular weight divided by the number of epoxy groups. Compounds that can also be used as component (B) are conventional cyclic carbonates such as ethylene carbonate or propylene carbonate, which are products of Huntsman Corp. known under trademarks Jeffsol® EC and Jeffsol® PC.

Components (A) and (B) are generally reacted in a required ratio using conventional methods and elevated temperature. FTIR spectroscopy control of cyclocarbonate group absence (1800 cm⁻¹) is used to detect the end point of the reaction. When reacting components (a) and (b), amine compounds can be added to the reaction system individually or in a mixture and at the same time or in sequence.

Optionally, one or more amines (C), which are different from adducts (A) and which comprise at least one primary amino group, can be added to the hydroxyamine composition. Polyamines (C) are, for example, those that were described above for preparing epoxy-amine adducts (A).

Hydroxyamine adducts are used as hardeners for liquid oligomer compositions (D) on the basis of one or more epoxy compounds (D1) with one or more terminal oxyrane groups. In addition to epoxy compounds, the resin portion of oligomer compositions may comprise one or more compounds (D2) that contain at least one terminal cyclocarbonate group or one or more compounds (D3) that contain at least one terminal acrylic or/and methacrylic group or a mixture (D4) of two or more compounds (D2) and/or (D3).

### ABBREVIATIONS

The following abbreviations are used in subsequent descriptions.

### Amines and Components of Amine Hardeners

DETA diethylenetriamine
TETA triethylenetetramine
PEPA polyethylenepolyamine
MPDA 2-methyl-1,5-pentanediamine
MXDA meta-xylylenediamine
TMD 2,2,4-(2,4,4)-trimethyl-1,6-hexanediamine
IPDA isophoronediamine
DADCM 4,4′-diaminodicyclohexylmethane
BA benzyl alcohol

### Epoxy Resins, Compounds, and Modifiers

DGEBA diglycidyl ether of Bisphenol A (liquid 100% epoxy resin)
BGE butyl glycidyl ether
PO propylene oxide
AGE aliphatic glycidyl ether

### Commercially Available Epoxy Resins

331 D.E.R.® 331 (Dow Chemical), liquid 100% epoxy resin (DGEBA)
324 D.E.R.® 324 (Dow Chemical), liquid 100% epoxy resin 83% DGEBA+17% C₁₂₋₁₄ AGE)
431 D.E.N.® 431 (Dow Chemical), liquid 100% epoxy-Novolac resin
1510 Eponex® 1510 (Hexion), hydrogenated DGEBA
R14 Polypox® R14 (UPPC GmbH), diglycidyl ether of neopentyl glycol
400 M-cure® 400 (Sartomer), aliphatic acrylate modifier for epoxy/amine systems

### Cyclic Carbonates

L 803 Laprolat® 803 (Macromer Co., Russia), polyoxypropylated trimethylol propane with cyclocarbonate terminal groups
PC Jeffsol® PC (Huntsman Corp.), propylene carbonate
TCTMP tricyclocarbonate of trimethylol propane (on the base of Polypox® R20, UPPC GmbH) in accordance with U.S. Pat. No. 7,232,877, examples 11 (Stage 11) and 6.

### Other Terms

EEW epoxy equivalent weight, g/eq.
AHEW amine hydrogen equivalent weight, g/eq.
CCEW cyclic carbonate equivalent weight, g/eq.
η viscosity

TABLE 1
Epoxy-amine Adducts

| | | | | Viscosity, |
|---|---|---|---|---|
| Name | Manufacturer | Description | AHEW | 25° C., mPa · s |
| D.E.H. ® 52 | Dow Chemical | Adduct DETA and DGEBA, DETA | 45 | 6,300 |
| EPI-CURE ® 3282 | Hexion | Adduct PEPA and DGEBA, BGE, | 38 | 4,100 |
| | | DETA | | |
| Ancamine ® 1618 | Air Products | Adduct, IPD, BA | 111 | 400 |
| Ancamine ® 1769 | Air Products | Adduct TETA and PO, TETA | 48 | 600 |
| Ancamine ® 2143 | Air Products | Adduct DADCM and DGEBA, | 115 | 600 |
| | | DADCM, BA | | |

Production of Hydroxyamine Adducts from Epoxy-Amine Adducts (A) and Cyclocarbonates (B)

Epoxy-amine adduct (A) or the mixture of hydroxyamine adduct (A) with amine (C) was carefully mixed with a cyclocarbonate and heated to 60 to 70° C., whereby a reaction took place. The mixture was maintained from 60 to 70° C. until the end of the reaction. The end point of the reaction was determined by FTIR spectroscopy by measuring reduction of the 1800 cm⁻¹ band to 95% conversion.

Compositions of the invention that contain hydroxyamine adducts and liquid-reaction oligomers can be selected from those listed in Tables 2 and 3, respectively.

TABLE 2
Hydroxyamine Adducts

| | | | | Ratio* | Process | η, 25° C., |
|---|---|---|---|---|---|---|
| Desc. | Epoxy-amine Addict A | Amine C | Cyclocarbonate B | A:C:B | Parameters | mPa · s |
| HA1 | D.E.H. ® 52 | IPDA | PC | 2:3:1 | 70° C./3 h | 900 |
| HA2 | EPI-CURE ® 3282 | MXDA | PC | 1:3:1 | 70° C./2 h | 800 |
| HA3 | Ancamine ® 1618 | TMD | L 803 | 5:2:1 | 80° C./2 h | 1,300 |
| HA4 | Ancamine ® 1769 | MPDA | L 803 | 3:2:1 | 70° C./2 h | 1,700 |
| HA5 | Ancamine ® 2143 | MXDA | TCTMP | 2:2:1 | 100° C./4 h | 1,500 |
| HA6 | Ancamine ® 1618 | — | L 803 | 10:0:1 | 90° C./2 h | 1,100 |
| HA7 | Ancamine ® 1769 | — | L 803 | 3:0:1 | 90° C./2 h | 2,100 |
| HA8 | — | MXDA | L 803 | 0:5:1 | 80° C./3 h | 4,400 |

*Amino group equivalents of epoxy-amine adduct (A) to amino group equivalents of amine (C) and to carbonate equivalents (B).

Commercially available amine adducts used in the composition of the invention may contain a compound or combination of compounds selected from the group consisting of water, at least one organic solvent, and a conventional additive. In this case, the aforementioned compounds will also be included into the composition as components thereof.

TABLE 3
Liquid-reaction Oligomers

| | | | | | Taber abrasion* |
|---|---|---|---|---|---|
| | Hydroxy- | | | Acrylic | (ASTM D4060), |
| | amine | Epoxy | Cyclocarbonate/ | Oligomer/ | 1000 cycles/1000 g, |
| Desc. | Adduct | Resin/Parts | Parts | Parts | CS-17 wheel, mg |
| OC1 | HA1 | 324/100 | — | — | 34 |
| OC2 | HA2 | 331/80 + R14/20 | — | — | 29 |
| OC3 | HA3 | 431/70 + R14/20 | PC/10 | — | 25 |
| OC4 | HA4 | 1500/80 | L 803/20 | — | 31 |
| OC5 | HA5 | 324/80 | L 803/20 | | 29 |
| OC6 | HA6 | 331/80 | — | 400/20 | 38 |
| OC7 | HA7 | 324/70 | L 803/10 | 400/20 | 30 |
| OC8 | HA8 | 324/80 | L 803/20 | — | 92 |

*A test to determine resistance to abrasion. Resistance to abrasion is defined as the ability of a material to withstand mechanical action such as rubbing, scraping, or erosion.

In all cases, the ratio of the amino group equivalents of the hydroxyamine adduct to the sum of epoxy group equivalents, acrylate double-bond equivalents, and carbonate equivalents was equal to 1:1, i.e., to a ratio essentially close to stoichiometry.

### APPLICATION EXAMPLES

Two compositions of floor coatings (F1 and F2) were prepared on the basis of hydroxyamine adducts (see Table 4).

Hydroxyamine adduct, epoxy resin, and cyclic carbonate (or acrylate) were mixed with use of an electrical stirrer. Pigments and surface-active additives were dispersed in the customary manner.

To prepare testing samples, end compounds were poured into Teflon forms, on concrete blocks 25×25×10 cm³ (layer 2 mm), and on metal testing plates (Taber abrasion).

TABLE 4
Composition and Properties of Flooring Compounds

| | Parts by weight | |
|---|---|---|
| Composition | F1 | F2 |
| Hydroxyamine adduct HA4 | 50.0 | — |
| Hydroxyamine adduct HA6 | — | 50.0 |
| D.E.R. ® 324 | 45.0 | 40.0 |
| Laprolat ® 803 | 5.0 | — |
| M-cure ® 400 | — | 10 |
| Titanium dioxide | 5.0 | 5.0 |
| Carbon black | — | 0.1 |
| BYK ®-A530 (surface-active additive of BYK Co.) | 2.0 | — |
| BYK ®-320 (surface-active additive of BYK Co.) | — | 1.5 |
| Properties | Values | |
| Mixed viscosity, 25° C., mPa · s | 1,450 | 970 |
| Pot-Life, 25° C., min | 30-60 | 30-60 |
| Tack free, 25° C., hr | 4 | 6 |

After 7 days at room temperature, substrate - concrete

| | | |
|---|---|---|
| 60° Film Gloss | 100-105 | 115-120 |
| Hardness, Shore D | 70-80 | 70-80 |
| Tensile strength, kg/mm² | 5-6 | 6-7 |
| Elongation at break, % | 5-7 | 3-4 |
| Taber abrasion, 1000 cycles/1000 g, CS-17 wheel, mg | 27 | 29 |
| Weight gain, 7 days water, 25° C., % | 2-3 | 1-2 |
| Impact resistance, N · m, ≧ | 20 | 20 |

As seen in Table 4, floor coatings prepared on the basis of the liquid oligomer composition containing hydroxyamine adducts possessed excellent performance properties.

The invention also provides a method of manufacturing a liquid oligomer composition. The method consists of providing at least one primary amine, at least one epoxy oligomer, at least one cyclocarbonate, and a reacting oligomer; obtaining a first adduct of epoxy oligomer with the primary amine by reacting at least one primary amine with at least one epoxy oligomer; obtaining a second adduct by reacting the first adduct with at least one cyclocarbonate; and mixing the second adduct with the reacting oligomer. The reacting oligomer can be selected from the group consisting of an epoxy oligomer, a cyclocarbonate oligomer, and an acrylic oligomer. Specific examples of the components used in the above methods are the same as disclosed above with respect to liquid oligomer compositions that contain hydroxyamine adducts.

Thus, it has been shown that the invention provides hydroxyamine adducts and coating media based on oligomer systems that contain the aforementioned hydroxyamine adducts as hardeners. The aforementioned hydroxyamine adducts differ from existing aminourethanes in that the hydroxyamine adducts are products of the reaction of cyclocarbonate compounds with conventional amines and at the same time constitute products of a reaction of cyclocarbonate compounds with epoxy-amine adducts.

Although the invention is described with reference to specific embodiments, these embodiments should not be construed as limiting the areas of application of the invention and that any changes and modifications are possible provided that these changes and modifications do not depart from the scope of the attached patent claims.

1. A liquid oligomer composition containing at least one hydroxyamine adduct and at least one liquid reacting oligomer, wherein at least one hydroxyamine adduct comprises:
(A) at least one epoxy-amine adduct, which contains at least one primary amine group comprising a product of a reaction of (a) at least one epoxy compound with at least one terminal oxyrane group and (b) at least one amine that contains at least two primary amino groups, wherein 1 to 15 moles of at least one amine (b) are reacted per equivalent of at least one epoxy compound (a) to form at least one epoxy-amine adduct (A); and
(B) at least one compound with at least one terminal cyclocarbonate group.

2. The liquid oligomer composition of claim 1, wherein said at least one hydroxyamine adduct further comprises at least one amine, which is the same as or different from at least one amine (b) and which further comprises one or more of primary, secondary, or tertiary groups.

3. The liquid oligomer composition of claim 2, wherein said at least one hydroxyamine adduct further comprises a compound or combination of compounds selected from the group consisting of water, at least one organic solvent, and a conventional additive.

4. The liquid oligomer composition of claim 1, wherein at least one epoxy compound (a) with at least one terminal oxyrane group is selected from the group consisting of diglycidyl ethers of bisphenol-A or bisphenol-F, polyglycidyl ethers of Novolac resin with oxyrane functionality from 2.2 to 4, di- or polyglycidyl ethers of aliphatic polyols, monofunctional reactive diluents selected from aliphatic and aromatic glycidyl ethers or esters, or a mixture of the above components.

5. The liquid oligomer composition of claim 4, wherein at least one epoxy compound (a) with at least one terminal oxyrane group is selected from the group comprising a mixture of two or more of the following components: diglycidyl ethers of bisphenol-A or bisphenol-F, polyglycidyl ethers of Novolac resin with oxyrane functionality from 2.2 to 4, di- or polyglycidyl ethers of aliphatic polyols, [and ? or?] monofunctional reactive diluents selected from the aliphatic and aromatic glycidyl ethers or esters.

6. The liquid oligomer composition of claim 4, wherein at least one epoxy compound (a) with at least one terminal oxyrane group is selected from the group consisting of diglycidyl ethers of bisphenol-A or bisphenol-F, polyglycidyl ethers of Novolac resin with oxyrane functionality from 2.2 to 4, di- or polyglycidyl ethers of aliphatic polyols, monofunctional reactive diluents selected from aliphatic and aromatic glycidyl ethers or esters, or a mixture of the above components.

7. The liquid oligomer composition of claim 6, wherein at least one epoxy compound (a) with at least one terminal oxyrane group is selected from the group comprising a mixture of two or more of the following components: diglycidyl ethers of bisphenol-A or bisphenol-F, polyglycidyl ethers of Novolac resin with oxyrane functionality from 2.2 to 4, di- or polyglycidyl ethers of aliphatic polyols, and monofunctional reactive diluents selected from the aliphatic and aromatic glycidyl ethers or esters.

8. The liquid oligomer composition of claim 1, wherein at least one amine (b) is selected from the following groups consisting of an aliphatic amine, a cycloaliphatic amine, and a polyoxyalkylene amine.

9. The liquid oligomer composition of claim 8, wherein at least one amine (b) is a mixture of two or more of an aliphatic amine, a cycloaliphatic amine, and a polyoxyalkylene amine.

10. The liquid oligomer composition of claim 1, wherein at least one compound (B) with at least one terminal cyclocarbonate group is selected from the group consisting of an aliphatic cyclocarbonate and polyoxyalkylene cyclocarbonate.

11. The liquid oligomer composition of claim 10, wherein at least one compound (B) with at least one terminal cyclocarbonate group is a mixture of aliphatic cyclocarbonate and polyoxyalkylene cyclocarbonate.

12. The liquid oligomer composition of claim 1, wherein at least one compound (B) with at least one terminal cyclocarbonate group is selected from the group consisting of aliphatic cyclocarbonate and polyoxyalkylene cyclocarbonate.

13. The liquid oligomer composition of claim 12, wherein at least one compound (B) with at least one terminal cyclocarbonate group is a mixture of aliphatic cyclocarbonate and polyoxyalkylene cyclocarbonate.

14. The liquid oligomer composition of claim 4, wherein at least one compound (B) with at least one terminal cyclocarbonate group is selected from the group consisting of aliphatic cyclocarbonate and polyoxyalkylene cyclocarbonate.

15. The liquid oligomer composition of claim 14, wherein at least one compound (B) with at least one terminal cyclocarbonate group is a mixture of aliphatic cyclocarbonate and polyoxyalkylene cyclocarbonate.

16. A method of manufacturing a liquid oligomer composition comprising the following steps: providing at least one primary amine, at least one epoxy oligomer, at least one cyclocarbonate, and a reacting oligomer; obtaining the first adduct of epoxy oligomer with the primary amine by reacting at least one primary amine with at least one epoxy oligomer; and obtaining a second adduct by reacting the first adduct with at least one cyclocarbonate and mixing the second adduct with the reacting oligomer.

17. The method of claim 16, wherein the reacting oligomer is selected from the group consisting of an epoxy oligomer, a cyclocarbonate oligomer, and an acrylic oligomer.
